(19) United States
(12) Patent Application Publication
(10) Pub. No.: US 2003/0235302 A1
(43) Pub. Date: Dec. 25, 2003

(54) System and method for supporting viewing of internet broadcasts

(76) Inventor: Eun-Mook Ji, Kyungki-do (KR)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 10/381,687

(22) PCT Filed: Sep. 26, 2001
(86) PCT No.: PCT/KR01/01619

(30) Foreign Application Priority Data
Sep. 27, 2000 (KR) 2000/56773

(51) Int. Cl. H04N 7/167

(52) U.S. Cl. 380/201; 705/57

(57) ABSTRACT

Disclosed is a system and method for supporting viewing of Internet broadcasts, providing a program download service to link users to the Internet broadcasting stations, and it enables the users to freely download various programs and execute the collected programs. In sending a program to a user terminal, a part of the data constituting the program is removed and the rest is arranged in a changed order lest the user executes the downloaded program without a specific executive program and an editing code. To execute the collected programs on the user terminal, the user must have access to the broadcast system to gain approval for the use of the programs and receive an editing code for restoration of the data structure of the programs. The user also receives a taken-away part of the program data and executes the downloaded programs using a specific executive program on the user terminal.

### BACKGROUND OF THE INVENTION

(a) Field of the Invention

The present invention relates to a system and method for supporting viewing of Internet broadcasts. More particularly, the present invention relates to a system and method for supporting viewing of Internet broadcasts that enables users to easily watch and listen to various broadcasting programs supplied on the Internet.

(b) Description of the Related Art

Recently, the advance of networks including the Internet has promoted the appearance of different kinds of contents data-providing services.

In the past, contents data included no more than simple motion pictures, music files, or clip art. Owing to high-speed communication and popularization of user terminals, many Internet broadcasting stations that provide the same broadcast programs as normal broadcasting stations have recently appeared in all the countries of the world, including about 50 to 60 in Korea. Numerous Internet broadcasting stations are spread in all over the world, including about 50 to 60 Internet broadcasting stations in Korea.

However, there is no service for connecting the various worldwide stations and providing links to the Internet broadcasting stations with a detailed explanation in each native language.

The current Internet broadcasting stations mostly provide a plurality of broadcast programs in real time so that the individual users watch and listen to the programs through their terminals on the Internet.

It is therefore impossible for the users to download various programs of interest, such as movies, dramas, cartoons, novels, etc. to their terminals and readily watch and listen to one of the collected programs at a convenient time.

### SUMMARY OF THE INVENTION

It is an object of the present invention to provide a system and method for supporting viewing of Internet broadcasts, which provides a service for guiding numerous Internet broadcasting stations broadcasting various programs in all the countries of the world, in each native language, and which provides a simple link to the Internet broadcasting stations of interest.

It is another object of the present invention to provide a service that enables the user to download various programs of interest produced by the individual Internet broadcasting stations to his/her terminal and readily execute or watch and listen to the collected programs at a convenient time.

To prevent unauthorized copying of the programs provided to the user, the data structure of each program is converted so that the user must have access to the broadcast system in order to execute the programs downloaded to his/her terminal.

In addition, the latest advertisement data as well as various programs are stored in the user terminal so that advertisements are also provided while the user views worldwide Internet broadcasts or executes the contents downloaded or collected on his/her terminal.

In one aspect of the present invention, there is provided a system for supporting viewing of Internet broadcasts that is linked to an Internet broadcasting station to receive a number of programs and is entrusted with business activities of various programs by a number of copyright holders to provide the programs to a user terminal connected via the Internet, the system including: a contents data control server for converting a data structure of each program, downloading the program to the user terminal, and making restoration information necessary for restoration of the converted data structure; and a data-storing unit for storing the restoration information necessary for restoration of the converted data structure. The contents data control server sends the restoration information stored in the data-storing unit to the user terminal so that the program stored in the user terminal can be restored and executed, when the user terminal has access to the contents data control server.

The contents data control server includes: a principal data manager for separating a part of the data of the program lest the program be executed by the user terminal; an editing code manager for making an editing code including the restoration information of the program; and a contents data converter for dividing the data of the program into parts and arranging the divided parts of the data in a changed order to convert the data structure of the program.

The data-storing unit includes: a principal data DB for storing a part of the program data separated by the principal data manager; an editing code DB for storing the editing code; and a contents DB for storing contents data converted by the contents data converter.

The programs provided to the user terminal include video data including movies, dramas, cartoons or novels that are produced by the Internet broadcasting station and are viewed by the user through the user terminal; and various programs for personal and business purposes as well as various computer games that are executed by the user terminal.

The editing code is a code indicating the original order of the divided parts of the program data prior to conversion performed by the contents data converter.

In another aspect of the present invention, there is provided a service-providing method of an Internet broadcast system for sending a plurality of programs to a user terminal connected via the Internet, i.e., a method for supporting viewing of Internet broadcasts including: (a) converting the data structure of each program and storing a part of the data necessary for execution of the program separately from the rest; (b) upon the user terminal requesting sending of a specific program, sending the data of the program having the converted data structure to the user terminal; and (c) upon the user terminal requesting approval for the use of the program, sending to the user terminal an editing code including information about the data structure of the program and the part of the data separately stored in step (a) so that the user terminal may execute the program.

Conversion of the data of the program includes dividing-the data of the program into parts and arranging the divided parts in a changed order, and the editing code is a code indicating the original order of the divided parts of the program data prior to conversion.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a schematic of a system for supporting viewing of Internet broadcasts in accordance with the present invention;

FIG. 2 is a flow chart showing the broadcasting procedure of the system for supporting viewing of Internet broadcasts in accordance with the present invention; and

FIG. 3 is a schematic of program execution data sent to a user terminal.

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive.

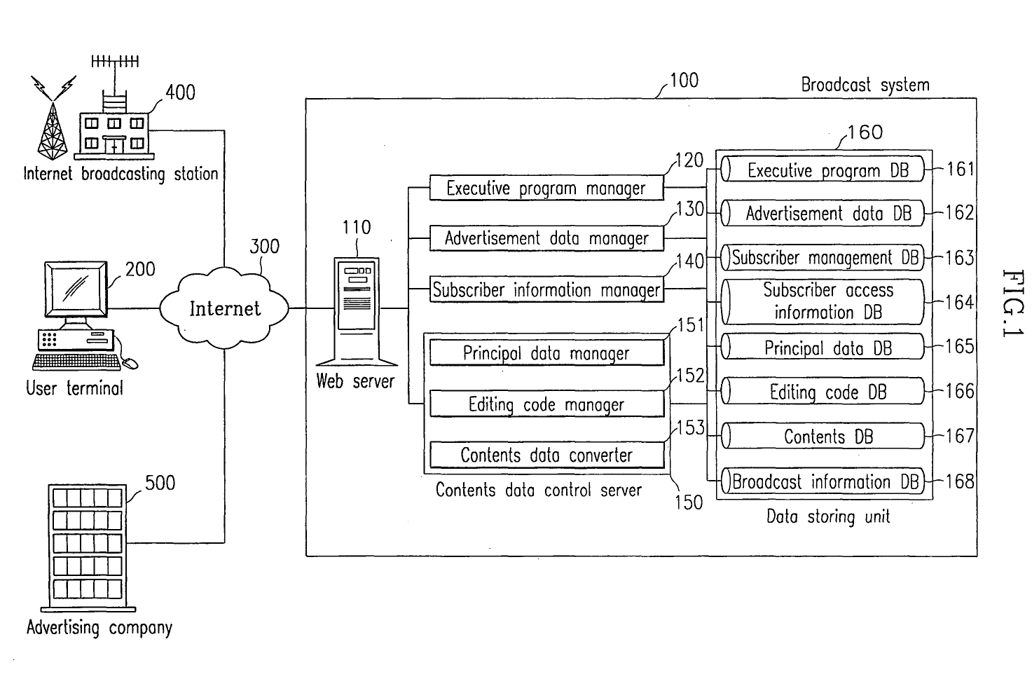

FIG. 1 depicts the structure of a system 100 for supporting viewing of Internet broadcasts (hereinafter, referred to as “broadcast system”) according to an embodiment of the present invention.

As illustrated in FIG. 1, the broadcast system 100 is connected to a user terminal 200, an Internet broadcasting station 400 and an advertising company 500 via the Internet 300.

The broadcast system 100 comprises a web server 110, an executive program manager 120, an advertisement data manager 130, a subscriber information manager 140, a contents data control server 150, and a data-storing unit 160.

The web server 110 performs a web function that enables a number of user terminals 200 to have access to contents data on the Internet 300, and sends various data and contents provided by the broadcast system 100 to the user terminals 200.

Once worldwide Internet users have access to the web server 110 of the broadcast system 100 via the user terminals 200, the web server 100 links the Internet users to the system of each Internet broadcasting station 400 in all the countries of the world. The users are enabled to have access to the homepage of the broadcast system 100 through their user terminals 200, so that they look over a list of programs from the Internet broadcasting station 400 in their native language and select a program of interest to view.

The executive program manager 120 sends to the user terminal 200 an executive program for executing contents downloaded on the user terminal 200.

The users are free to download a variety of contents, such as movies, dramas, cartoon, novels, computer games or the like, from the broadcast system 100. To execute downloaded contents, the users have to install a specific executive program, sent from the broadcast system 100, on the user terminal 200.

The executive program includes Real player or Media player as a program for executing multimedia data such as motion picture data, voice data, etc., and it must be installed on the user terminal 200.

The advertisement data manager 130 converts various advertisements, produced by the advertising company 500, to a format transmittable via the Internet 300, and sends the converted advertisement data to the user terminal 200.

When the user terminal 200 is connected to the broadcast system 100, the advertisement data manager 130 updates new advertisement data and saves them in the user terminal 200 so that the advertisement data can be broadcast to the user while the user is watching and listening to an Internet broadcast or executing the downloaded contents.

The advertisement data manager 130 reads the advertisement data from the user terminal 100 to determine whether the advertisement data are up to date, and updates overdue advertisement data when they are found to have expired, so that the user can view the latest advertisement at any time.

The technology for storing advertisement data in the user terminal 200 and executing advertisement on line or off line is well known to those skilled in the art and will not be described in detail.

The subscriber information manager 140 stores in the data-storing unit 160 personal information of subscribers, i.e., users subscribing to various contents from the broadcast system 100, and when a user has access to the broadcast system 100 on the Internet, determines from the stored personal information of the subscribers whether the user is registered.

While the user as a subscriber has access to the broadcast system 100 to watch and listen to various Internet broadcasts and use or download different contents, the subscriber information manager 140 checks information concerning the viewed programs, downloaded contents and access time, and stores it in the data-storing unit 160.

The subscriber information manager 140 sends commercial advertisements and broadcast program advertisements of utmost suitability for the individual subscriber's tastes to the individual user terminal 200, based on the subscriber's personal information including hobbies and access history, to the broadcast system 100.

The technology for sending advertisements suitable for the individual user's occupation, age, sex, hobbies, or the like based on the information of the users connecting to the broadcast system 100 on the Internet is well known to those skilled in the art and will not be described in detail.

The contents data control server 150 comprises a principal data manager 151, an editing code manager 152, and a contents data converter 153.

The principal data manager 151 separately stores a specific part of various contents data supplied from the broadcast system 100 and sends the rest to the user terminal 200. The specific part of the contents data is absolutely necessary for the user to execute the downloaded contents, and preferably has the shortest length possible.

To execute the downloaded and stored contents, the user must access the broadcast system 100, be authenticated, and receive the specific part separated by the principal data manager 151.

The editing code manager 152 generates an editing code necessary for execution of the contents data and sends it to the user terminal 200. The editing code refers to a secret code for executing contents data and includes rules necessary for recombination of irregularly converted contents data back to their original format.

The contents data converter 153 converts the contents data sent to the user terminal 200 to a complicated and irregular structure and sends the converted data to the user terminal 200. The conversion is to alter the structure of the contents data to prohibit the user from accessing the broadcast system 100 to execute the downloaded contents data without approval.

The data conversion method is not specifically limited. For example, a method may divide contents data into twenty parts and change the order of the divided parts to make execution of the data impossible.

The editing code manager 152 generates an editing code storing the original order of the changed data parts and sends it to the user terminal 200 so that the user may execute the contents data.

The data-storing unit 160 comprises an executive program DB (Data-Base) 161, an advertisement data DB 162, a subscriber management DB 163, a subscriber access information DB 164, a principal data DB 165, an editing code DB 166, a contents DB 167, and a broadcast information DB 168.

The executive program DB 161 stores executive programs sent to the user terminal 200 from the executive program manager 120.

The advertisement data DB 162 stores various advertisements produced in the form of text, voice, motion picture, etc. by the advertising company 500.

The advertisement data manager 130 periodically updates various advertisements stored in the advertisement data DB 162 so that the users are in contact with new advertisements at any time.

The subscriber management DB 163 stores the personal information (e.g., hobbies, tastes, etc.) of the users registered as subscribers to the broadcast system 100.

The subscriber access information DB 164 stores various records indicating the individual subscriber's viewed Internet broadcast programs, downloaded contents, the type and frequency of advertisements or use tendency, and sends the information to the subscriber information manager 140.

The principal data DB 165 stores the specific data separated by the principal data manager 151.

The editing code DB 166 receives an editing code, used to recombine the contents data, from the editing code manager 152 and stores it.

The contents DB 167 stores various kinds of contents transmitted by the broadcast system 100.

The contents data include movies, dramas, cartoons, novels, computer games, etc. that are produced by the broadcast system 100, or a plurality of Internet broadcasting stations 400 linked to the broadcast system 100 via the Internet 300.

Namely, the broadcast system 100 stores contents supplied from the worldwide individual broadcasting stations 400 in the contents DB 167, or connects the contents DB of the contents-providing Internet broadcasting station 400 to its contents DB through the web server on the Internet. And, the broadcast system 100 sends the contents to the user terminal 200 by request. Alternatively, the broadcast system 100 self-produces the contents such as movies, dramas, cartoons, novels, computer games, etc., converts them to contents data, stores the contents data in the contents DB 167 and sends them to the individual user terminal 200.

The broadcast system 100 specially converts various contents data stored in the contents DB 167 and sends them to the user terminal 200 so that the user registered as a subscriber can use the contents.

The broadcast information DB 168 stores the address of each Internet broadcasting station 400 all over the world, the title and contents of broadcast programs, and a list of contents available for download service, and displays them on the homepage of the broadcast system 100 so that the users can readily watch and listen to the worldwide Internet broadcasts and use the download service.

The broadcast system 100 links the web sites of the Internet broadcasting stations 400 for the user to watch and listen to various Internet broadcasts from all over the world. The user looks over a list of numerous broadcasting stations and broadcast programs stored in the broadcast information DB 168 and clicks on one broadcasting station and one broadcast program to watch and listen to the selected broadcast program.

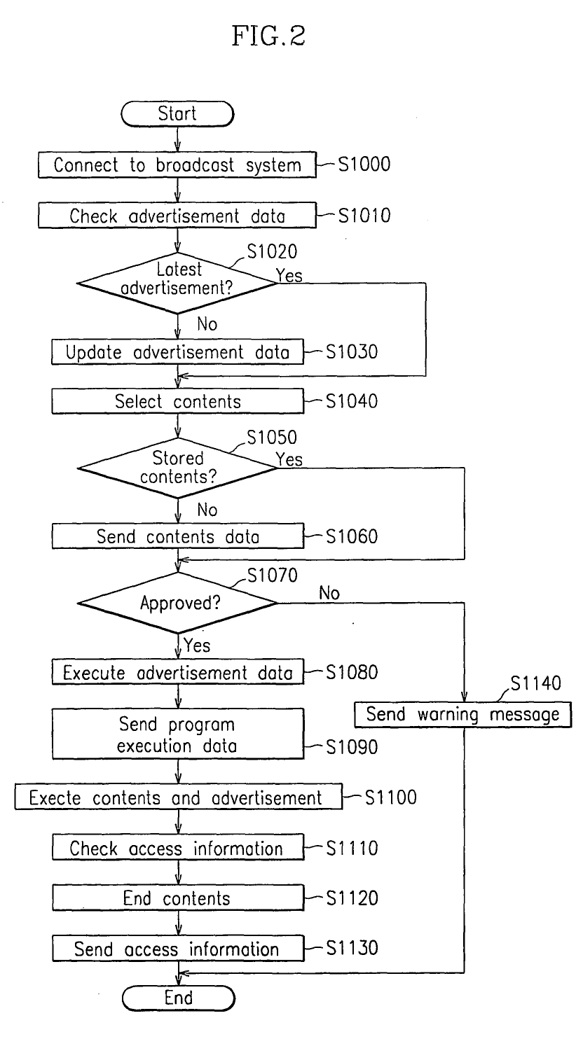

Now, a description will be given of the operation of the broadcast system 100 according to an embodiment of the present invention with reference to FIG. 2.

FIG. 2 shows a flow chart showing the broadcast system 100 sending contents to the connected user terminal 20 and the user executing the received contents.

First, the user who desires to view worldwide Internet broadcasts using the broadcast system 100 and download various contents must connect his/her terminal 200 to the broadcast system 100 via the Internet 300, in step S1000.

The advertisement data manager 130 reads advertisement data stored in the user terminal 200, in step S1010, and determines in step S1020 whether the previously stored advertisement data are up to date.

If the advertisement data stored in the user terminal 200 are not the latest, the advertisement data manager 130 sends the latest advertisement (ad. 1) stored in the advertisement data DB 162 to the user terminal 200 via the web server 110 and updates the advertisement data, in step 1030. If the advertisement data are up to date, the advertisement data manager 130 leaves the advertisement data intact. In the case where the user terminal 200 has no advertisement data downloaded, i.e., the user of the terminal 200 is not registered as a subscriber to the broadcast system 100, the broadcast system 100 gives the user a detailed explanation of how to register as a subscriber and use the contents through the homepage.

The user selects contents of interest from a list of programs available for download on the homepage of the broadcast system 100, in step S1040.

The subscriber information manager 140 reads the data stored in the subscriber access information DB 164 and accesses the terminal 200 of the user to check whether the selected contents data have already been downloaded on the user terminal 200, in step 1050. If the contents are not stored in the user terminal 200, the contents data control server 150 sends the selected contents to the user terminal 200, in step 1060.

Otherwise, if the selected contents are stored in the user terminal 200, the user proceeds to the approval step.

Since the contents data downloaded on the user terminal 200 are incomplete data free from a specific part with the order of the data changed, the user is unable to execute the contents data without connection to the broadcast system 100. Thus the user must have access to the broadcast system 100 in order to execute the corresponding contents.

To execute the downloaded contents data, the user must gain approval of the subscriber information manager 140 in the broadcast system 100. The subscriber information manager 140 reads the user information from the subscriber management DB 163 and the subscriber information from the user terminal 200 to determine whether the user is registered, in step 1070.

If the user is not registered, the subscriber information manager 140 sends a warning message to the user terminal 200 and ends the process, in step 1140.

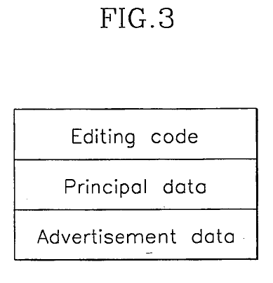

Once the user gains approval of the broadcast system in regard to use of contents, a specific executive program in the user terminal reads the advertisement data (ad. 1) updated in the user terminal 200 by the advertisement data manager 130 and executes them on the user terminal 200, in step 1080. During execution of the advertisement data, the contents data control server 150 sends program execution data shown in FIG. 3 to the user terminal 200, in step 1090.

The program execution data comprise editing code, principal data and advertisement data. The editing code includes information about the original order of contents data of which the order is changed. The principal data is a specially isolated part of the contents data necessary for execution of the contents data. The advertisement data (ad. 2) are the latest advertisements of different types supplied from the contents-providing Internet broadcasting station 400 or the broadcast system 100 for the sake of profits.

Immediately after execution of the latest advertisement data (ad. 1) ends, the specific executive program in the user terminal 200 uses the received editing code to rearrange the contents data into the original order, adds the principal data to the empty part of the contents data, and executes the contents data together with the advertisement data (ad. 2), in step 1100.

The subscriber information manager 140 starts to check the execution time the moment the user executes the contents data, and checks the contents of the contents data and the type and frequency of advertisement data, in step 1110.

With the specific execution program in the user terminal 200 executing the contents data, the program such as a movie, drama, cartoon, novel or computer game chosen by the user is executed, at which time the advertisement data (ad. 2) included in the program execution data are also executed to play an advertisement to the user.

When the contents data terminate or the user inputs a termination signal during execution of the contents data, in step S1120, the user terminal 200 sends to the subscriber information manager 140 all access information including the contents of the accessed contents data, access time, the type and frequency of advertisement data (ads. 1 and 2), or the like, in step S1130. The subscriber information manager 140 stores the access information in the access information DB 164.

While this invention has been described in connection with what is presently s considered to be the most practical and preferred embodiment, it is to be understood that the invention is not limited to the disclosed embodiments, but, on the contrary, is intended to cover various modifications and equivalent arrangements included within the spirit and scope of the appended claims.

As described above, the embodiment of the present invention enables the users to readily visit Internet broadcasting stations in all the countries of the world with directions in their native language to watch and listen to various programs. The users are free to download contents data of interest, such as movies, dramas, cartoons, novels, etc., produced by the Internet broadcasting stations, from the broadcast system and execute the collected contents data at a convenient time. The users can also enjoy various programs of good sound quality in a definite and large-sized picture at any time without being disturbed by low speed or disconnection of the lnternet due to stagnation.

To view downloaded programs such as movies or dramas, the individual user must have access to the broadcast system to obtain approval of the broadcast system. Every time the user gains approval, the Internet broadcasting stations send the latest advertisement data (ads. 1 and 2) to the user terminal. This guarantees efficient control of customers and the most effective advertising, bringing about more advertising revenue.

Alternatively, contents such as movies or computer games with attached advertisements are offered free to the users to allow the users to freely collect the contents to their taste, which prevents unauthorized copying of various programs that frequently occurs on the Internet when the contents are charged for.

Since the Internet broadcasting stations convert program data available in a download service, the users who have a copy of the program data must have access to the broadcast system and gain approval of the broadcast system for the use of the program data in order to execute the program data. Thus the Internet broadcasting stations are free to offer all programs for a download service without fear of unauthorized copying of the programs.

Instead, the Internet broadcasting stations would expect worldwide users to freely download and collect all their programs.

What is claimed is:

1. A system for supporting viewing of network broadcasts, the system being linked to an network broadcasting station to receive a number of programs and being entrusted with business activities of various programs by a number of copyright holders to provide the programs to a user terminal connected via the network, the system comprising:
a contents data control server for converting a data structure of each program, downloading the program to the user terminal, and making restoration information necessary for restoration of the converted data structure; and
a data-storing unit for storing the restoration information necessary for restoration of the converted data structure,
the contents data control server sending the restoration information stored in the data-storing unit to the user terminal so that the program stored in the user terminal can be restored and executed, when the user terminal has access to the contents data control server.

2. The system as claimed in claim 1, wherein the restoration information is on occasion temporarily loaned to the user terminal on the network, the user terminal additionally receiving the restoration information whenever it executes the downloaded program, the restoration information being temporarily stored in a memory or hard disk of the user terminal and being used to restore the programs stored in the user terminal, and being automatically deleted immediately after being used.

3. The system as claimed in claim 1, wherein the contents data control server comprises:
a principal data manager for separating a part of the data of the program lest the user terminal execute the program;
an editing code manager for making an editing code including the restoration information of the program; and
a contents data converter for dividing the data of the program into parts and arranging the divided parts of the data in a changed order to convert the data structure of the program.

4. The system as claimed in claim 1, wherein the contents data control server comprises:
a principal data manager for separating a part of the data of the program lest the program be executed by the user terminal; and
a contents data converter for taking a part of the data of the program away from the data of the program to change the program and convert the data structure of the program so the program cannot be executed without adding the taken-away part into the data of the program.

5. The system as claimed in claim 1, wherein the contents data control server comprises:
a contents data converter for dividing the data of the program into parts and arranging the divided parts of the data in a changed order to convert the data structure of the program; and
an editing code manager for making an editing code including the restoration information of the program to restore the changed order of the divided parts of the program.

6. The system as claimed in claim 1, wherein the data-storing unit comprises:
a principal data DB for storing a part of the program data separated by a principal data manager;
an editing code DB for storing editing code; and
a contents DB for storing contents data converted by a contents data converter.

7. The system as claimed in claim 1, wherein the programs provided to the user terminal comprise video data including movies, dramas, cartoons or novels that are produced by the network broadcasting station and. are viewed by the user through the user terminal; and various programs for personal and business purposes as well as various computer games that are executed by the user terminal.

8. The system as claimed in claim 3, wherein the editing code is a code indicating the original order of the divided parts of the program data prior to conversion performed by the contents data converter.

9. The system as claimed in claim 5, wherein the editing code is a code indicating the original order of the divided parts of the program data prior to conversion performed by the contents data converter.

10. In a service-providing method of a network broadcast system for sending a plurality of programs to a user terminal connected via the network, a method for supporting viewing of network broadcasts, comprising:
(a) converting a data structure of each program and separately storing a part of the data necessary for execution of a program from the data;
(b) upon the user terminal requesting sending of a specific program, sending the data of the program having the converted data structure to the user terminal; and
(c) upon the user terminal requesting approval for use of the program, sending to the user terminal an editing code including information about the data structure of the program and the part of the data separately stored in step (a) so that the user terminal may execute the program.

11. The method as claimed in claim 10, wherein conversion of the data of the program includes dividing the data of the program into parts and arranging the divided parts in a changed order.

12. The method as claimed in claim 10, wherein the editing code is a code indicating the original order of the divided parts of the program data prior to conversion.

13. The method as claimed in claim 10, wherein the programs provided to the user terminal comprise video data including movies, plays or novels and are viewed by a user through the user terminal; and computer games executed by the user terminal.

14. The method as claimed in claim 12, wherein the programs provided to the user terminal comprise video data including movies, plays or novels and are viewed by a user through the user terminal; and computer games executed by the user terminal.

15. In a service-providing method of a network broadcast system for sending a plurality of programs to a user terminal connected via the network, a method for supporting viewing of network broadcasts, comprising:
(a) converting a data structure of each program and making an editing code including information about the structure of the program;
(b) upon the user terminal requesting sending of a specific program, sending the data of the program having the converted data structure to the user terminal; and
(c) upon the user terminal requesting approval for the use of the program, sending the editing code including information about the structure of the program to the user terminal so that the user terminal may execute the program.

16. The method as claimed in claim 15, wherein the programs provided to the user terminal comprise video data including movies, plays or novels and are viewed by a user through the user terminal; and computer games executed by the user terminal.

17. In a service-providing method of a network broadcast system for sending a plurality of programs to a user terminal connected via the network, a method for supporting viewing of network broadcasts, comprising:
(a) taking a part of the data of each program away from the data of each program to convert the program, and storing it;
(b) upon the user terminal requesting sending of a specific program, sending the data of the program having the converted data structure to the user terminal; and
(c) upon the user terminal requesting approval for the use of the program, sending the taken-away part of the program to the user terminal so that the user terminal may execute the program.

18. The method as claimed in claim 17, wherein the programs provided to the user terminal comprise video data including movies, plays or novels and are viewed by a user through the user terminal; and computer games executed by the user terminal.
